(19) United States
(12) Patent Application Publication
(10) Pub. No.: US 2023/0316335 A1
(43) Pub. Date: Oct. 5, 2023

(54) INFORMATION PROCESSING APPARATUS, INFORMATION PROCESSING METHOD, AND NON-TRANSITORY COMPUTER READABLE MEDIUM

(71) Applicant: Rakuten Group, Inc., Tokyo (JP)

(72) Inventors: Yu HIRATE, Tokyo (JP); Md Mostafizur RAHMAN, Tokyo (JP); Takuma EBISU, Tokyo (JP); Manoj KONDAPAKA, Tokyo (JP); Daisuke KIKUTA, Tokyo (JP); Satyen ABROL, Tokyo (JP); Maxence LEMERCIER, Tokyo (JP)

(73) Assignee: Rakuten Group, Inc., Tokyo (JP)

(21) Appl. No.: 18/191,502

(22) Filed: Mar. 28, 2023

(30) Foreign Application Priority Data
Mar. 31, 2022 (JP) 2022-058400

(51) Int. Cl. G06Q 30/0251; G06F 16/901; G06F 16/28; G06N 5/022

(52) U.S. Cl. CPC G06Q 30/0269; G06F 16/9024; G06F 16/288; G06N 5/022

(57) ABSTRACT

An information processing apparatus selects, from a plurality of users, a model user group and a target user group that is different from the model user group, generates, for each user of the target user group, a user representation representing relationships with the plurality of users and the plurality of items, and predicts, based on the user representation, one or more users that have features similar to those of users included in the model user group, from the target user group, as a similar user group.

### TECHNICAL FIELD

The present invention relates to an information processing apparatus, an information processing method, and a program thereof, and in particular, relates to a technique related to advertisement provision.

### BACKGROUND ART

In recent years, when advertisements are distributed through the Internet, selection (targeting) of a user group to which advertisements are to be distributed is performed. A technique disclosed in JP 2017-097717A is known as a targeting technique, for example. In JP 2017-097717A, a technique is described in which a group of consumers that are estimated to have purchased goods to be advertised is determined as an advertisement target, based on purchase histories of other goods, although there is no purchase history of the goods to be advertised.

JP 2017-097717A is an example of related art.

### SUMMARY OF THE INVENTION

In the technique disclosed in JP 2017-097717A, an advertisement distribution target is determined based on a database that stores features related to consumption behaviors of consumers belonging to a plurality of preset consumer groups. However, in this technique, relationships with a plurality of users and a plurality of items to be advertised that may influence the consumption behavior of a consumer (user) are not considered, and there is a problem in that effective targeting is not realized.

The present invention has been made in view of the above problem, and an object thereof is to provide a technique for realizing targeting in which relationships with a plurality of users and a plurality of items to be advertised are considered.

In order to solve the above problem, one aspect of an information processing apparatus according to the present invention includes: a selection unit configured to select, from a plurality of users, a model user group and a target user group that is different from the model user group; a generation unit configured to generate, for each user of the target user group, a user representation representing relationships with the plurality of users and the plurality of items; and a prediction unit configured to predict, based on the user representation, one or more users that have features similar to those of users included in the model user group, from the target user group, as a similar user group.

The information processing apparatus further includes a user feature acquisition unit configured to acquire factual features for each user of the plurality of users as user features, and the prediction unit may predict the similar user group based on the user features of the target user group and the user representations.

The information processing apparatus further includes a construction unit configured to construct a graph representing mutual relationships between the plurality of users and the plurality of items, and the generation unit may generate the user representations from the graph.

The information processing apparatus further includes an item feature acquisition unit configured to acquire features regarding a plurality of items as item features, and the construction unit may construct the graph based on the user features of the plurality of users and the item features.

The construction unit may construct a first relationship that is a relationship between the plurality of users, a second relationship that is a relationship between the plurality of items, and a third relationship that is a relationship between the plurality of users and the plurality of items, based on the user features of the plurality of users and the item features, and construct the graph using the first relationship, the second relationship, and the third relationship.

The information processing apparatus further includes a task setting unit configured to set a plurality of tasks representing classifications of the plurality of items from the item features, and the construction unit may construct, as the graph, a graph network representing mutual relationships between the plurality of users, the plurality of items, and the plurality of tasks, based on the user features of the plurality of users and the item features.

The plurality of tasks may respectively be brand names of the plurality of items.

The prediction unit may predict the similar user group using a learning model for machine learning that is configured to receive, as inputs, the user features of the target user group and the user representations, and outputs a likelihood of having features similar to those of users included in the model user group.

The prediction unit may predict one or more users having the likelihood larger than a predetermined threshold as the similar user group.

The information processing apparatus may further include a distribution unit configured to distribute an advertisement to the similar user group.

In order to solve the above problem, one aspect of an information processing method according to the present invention includes: selecting, from a plurality of users, a model user group and a target user group that is different from the model user group; generating, for each user of the target user group, a user representation representing relationships with the plurality of users and the plurality of items; and predicting, based on the user representation, one or more users that have features similar to those of users included in the model user group, from the target user group, as a similar user group.

In order to solve the above problem, one aspect of a program according to the present invention is an information processing program for causing a computer to execute information processing, and the program causes the computer to execute: selection processing for selecting, from a plurality of users, a model user group and a target user group that is different from the model user group; generation processing for generating, for each user of the target user group, a user representation representing relationships with the plurality of users and the plurality of items; and prediction processing for predicting, based on the user representation, one or more users that have features similar to those of users included in the model user group, from the target user group, as a similar user group.

According to the present invention, it is possible to realize targeting in which relationships between a plurality of users and a plurality of items to be advertised are considered.

The objects, aspects, and effects of the present invention described above and the objects, aspects and effects of the present invention not described above can be understood by a person skilled in the art based on the following modes for carrying out the invention by referring to the accompanying drawings and the description of the claims.

### BRIEF DESCRIPTION OF THE DRAWINGS

FIG. 1 shows an exemplary configuration of an information processing system.

FIG. 2 shows an exemplary functional configuration of an information processing apparatus 10 according to a first embodiment.

FIG. 3 shows a flowchart of a procedure for creating a knowledge graph.

FIG. 4A is a diagram for describing explicit links.

FIG. 4B is a diagram for describing implicit links.

FIG. 5 is a diagram for describing processing for inferring a relationship between links.

FIG. 6A shows a conceptual diagram of a score (closeness score) based on closeness of a relationship between a user pair.

FIG. 6B shows a schematic architecture of a score prediction model 112.

FIG. 6C shows a conceptual diagram of a user relationship graph.

FIG. 7 shows a conceptual diagram of an item relationship graph.

FIG. 8 shows a conceptual diagram of a user-item relationship graph.

FIG. 9 shows a conceptual diagram of a knowledge graph and a user representation.

FIG. 10 is a diagram for describing prospective user prediction processing according to the first embodiment.

FIG. 11 shows exemplary hardware configurations of the information processing apparatus 10 and a user apparatus 11.

FIG. 12 is a flowchart of processing to be executed by the information processing apparatus 10 according to the first embodiment.

FIG. 13 is an exemplary functional configuration of an information processing apparatus 10 according to a second embodiment.

FIG. 14 shows a flowchart of a GNN creation procedure.

FIG. 15 shows conceptual diagrams of GNN and a user representation.

FIG. 16 is a diagram for describing prospective user prediction processing according to the second embodiment.

FIG. 17 is a flowchart of processing to be executed by the information processing apparatus 10 according to the second embodiment.

### EMBODIMENTS OF THE INVENTION

Hereinafter, an embodiment for implementing the present invention will be described in detail with reference to the accompanying drawings. Constituent elements disclosed hereinafter that have the same function as each other are denoted by identical reference signs, and description thereof is omitted. Note that the embodiments disclosed hereinafter are examples serving as a means of realizing the present invention, the embodiments are to be amended or modified as appropriate according to the configuration of the apparatus to which the present invention is applied and various conditions, and the present invention is not limited to the following embodiments. Also, not all combinations of features described in the present embodiments are essential for the solving means of the present invention.

### First Embodiment

Configuration of Information Processing System

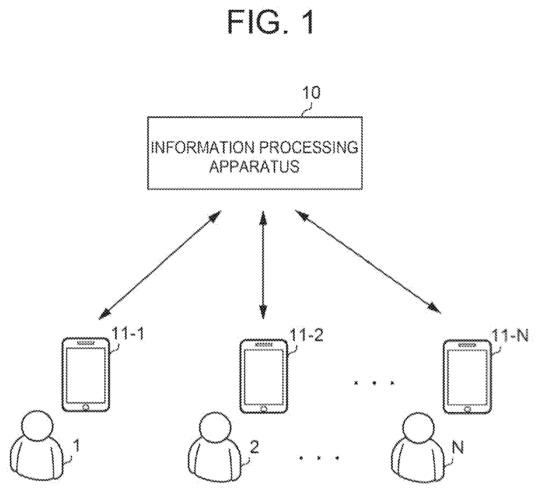

FIG. 1 shows an exemplary configuration of an information processing system according to the present embodiment. In one example, as shown in FIG. 1, the present information processing system includes an information processing apparatus 10, and a plurality of user apparatuses 11-1 to 11-N (N>1) used by any plurality of users 1 to N. Note that in the following description, the user apparatuses 11-1 to 11-N can be referred to collectively as user apparatuses 11 unless otherwise specified. Also, in the following description, the terms “user apparatus” and “user” can be used synonymously.

The user apparatus 11 is, for example, an apparatus such as a smartphone or a tablet, and can communicate with the information processing apparatus 10 via a public network such as LTE (Long Term Evolution) or a wireless communication network such as a wireless LAN (Local Area Network). The user apparatus 11 has a display unit (display screen) such as a liquid crystal display, and each user can perform various operations through a GUI (Graphic User Interface) installed in the liquid crystal display. The operations include various operations performed with a finger or a stylus on content such as images displayed on the screen, such as a tap operation, a slide operation, or a scroll operation.

Note that the user apparatus 11 is not limited to an apparatus of the form shown in FIG. 1, and may also be an apparatus such as a desktop PC (Personal Computer) or a laptop PC. In this case, the operations performed by each user can be performed using an input apparatus such as a mouse or a keyboard. Also, the user apparatus 11 may include a display screen separately.

The user apparatus 11 can use a service by logging into a web service (Internet-related service) provided via the information processing apparatus 10, from the information processing apparatus 10 or another apparatus (not shown). The web service can include an online mall, an online supermarket, or a service relating to communication, finance, real estate, sports, or travel, which are provided via the Internet. The user apparatus 11 can transmit information relating to the user of the user apparatus 11 to the information processing apparatus 10 by using such a web service.

For example, the user apparatus 11 can transmit information regarding features relating to the user apparatus or the user, such as the IP (Internet Protocol) address of the user apparatus 11, the address of the user, or the name of the user, to the information processing apparatus 10.

Also, the user apparatus 11 can perform positioning calculation based on signals or the like received from GPS (Global Positioning System) satellites (not shown), generate information obtained through the calculation as position information of the user apparatus 11, and transmit the generated information to the information processing apparatus 10.

The information processing apparatus 10 acquires various types of information from the user apparatus 11, acquires features regarding items from a predetermined database, and creates a graph network (graph) based on the acquired information. In the present embodiment, the information processing apparatus 10 creates a knowledge graph as the graph network. The knowledge graph is a directed graph that represents knowledge in the real world with a factual structure. In the present embodiment, the knowledge graph is constituted by a user relationship (interaction) graph, an item relationship graph, and a user-item relationship graph. Also, the information processing apparatus 10 extracts a user representation of any user (a feature vector, embedded representation, or vector representation of the user in a directed graph such as a knowledge graph) from the knowledge graph.

Functional Configuration of Information Processing Apparatus 10

The information processing apparatus 10 according to the present embodiment first acquires various user features from the user apparatuses 11-1 to 11-N, and acquires features regarding items from a predetermined database. In the present embodiment, the items may be tangible or intangible things that can be provided in various services. For example, there are items such as a bank account, a financial product such as stocks, an investment trust, or an insurance product, cryptocurrency, and smartphone payment application, for a finance (fintech) service. Also, there are items such as moving image contents such as movies and animations and still image contents such as photographs, illustrations, and text, for a digital content service. Also, there are items such as intangible or tangible goods that are handled in net shopping, for an e-commerce service. Also, there are items such as information regarding hotels, package tours, and transportation facilities and reservation, for a travel service. Also, there are items such as a mobile apparatus, a public network/Internet connection, and a communication usage charge, for a mobile service. Also, there are items such as offline and online advertisement products, direct mails, and advertisements through broadcasting and the Internet, for an advertisement and media service. Also, there are items such as credit card payment and point trade, for a card service. Also, there are items such as events such as sport events and concerts and products sold in events, for a sport and culture service.

The information processing apparatus 10 constructs a knowledge graph from the acquired user features and item features, and extracts a user representation for any user from the knowledge graph. The knowledge graph is constituted by a user relationship graph, an item relationship graph, and a user-item relationship graph, which will be described later. Moreover, the information processing apparatus 10 predicts, using the user representation, a prospective user having features similar to those of a predetermined (given) seed user (model user), the prospective user being highly likely to purchase the same item as the seed user, for example.

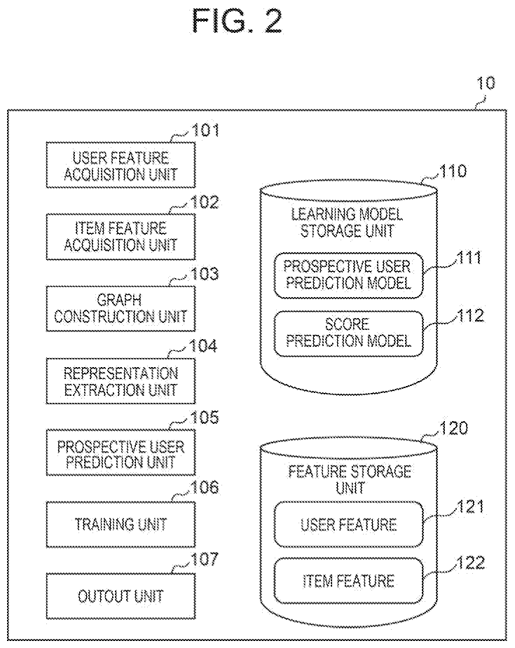

FIG. 2 shows an example of a functional configuration of the information processing apparatus 10 according to the present embodiment.

The information processing apparatus 10 shown in FIG. 2 includes a user feature acquisition unit 101, an item feature acquisition unit 102, a graph construction unit 103, a representation extraction unit 104, a prospective user prediction unit 105, a training unit 106, an output unit 107, a learning model storage unit 110, and a feature storage unit 120. The learning model storage unit 110 stores a prospective user prediction model 111 and a score prediction model 112. The various learning models will be described later. Also, the feature storage unit 120 is configured to store user features 121 and item features 122.

The user feature acquisition unit 101 acquires factual features (factual information) (hereinafter referred to as user features) about the user apparatuses or the users from each of the user apparatuses 11-1 to 11-N. The user features are features (information) based on facts actually or objectively acquired from the user apparatuses or the users. For example, the user feature acquisition unit 101 can directly acquire the user features from the user apparatuses 11. Also, the user feature acquisition unit 101 can acquire the user features as information registered with a predetermined web service by the users of the user apparatuses 11.

The user features include IP addresses of the user apparatuses, the addresses of the users or the names of the users, the numbers of credit cards possessed by the users, demographic information of the users (demographic user attributes such as sex, age, area of residence, occupation, and family composition), and the like. Also, the user features may include registration numbers and registration names used when using a predetermined web service. Also, the user features may include information relating to a call history, a delivery address other than the address of the user for a product at the time of using the predetermined web service, a use status during use of the predetermined web service, a use history (including a purchase history and a selling history), a search history, viewing history (including a click history), and points that can be accumulated through use of a service. Thus, the user features can include any information, including information relating to the user apparatus or the user, and information relating to use of a predetermined service through communication.

The user feature acquisition unit 101 stores the acquired user features in the feature storage unit 120 as the user features 121.

The item feature acquisition unit 102 acquires features (attributes) of an item from a predetermined database (not shown), based on registration information and a transaction history in various web services. The features of the item include information for identifying the item (hereinafter, item ID), information for identifying the genre (upper-level classification) of the item (hereinafter, genre ID), information for identifying the shop that sells the item (hereinafter, shop ID), and the like. An item feature can include transaction information (e.g., number of transactions) between an item ID and a genre ID and between an item ID and a shop ID according to the transaction history. The item feature acquisition unit 102 stores the acquired features of the item in the feature storage unit 120 as item features 122.

The graph construction unit 103 constructs a knowledge graph based on various features acquired from the user feature acquisition unit 101 and the item feature acquisition unit 102. The knowledge graph will be described later.

The representation extraction unit 104 extracts a user representation for any user from a knowledge graph constructed by the graph construction unit 103. The representation extraction unit 104 may also extract an item representation for any item from the knowledge graph. The processing for extracting the user representation (or, item representation) will be described later. Also, the representation extraction unit 104 may extract an embedded representation (vector representation) regarding any node in the constructed knowledge graph, as a shop representation or a genre representation, for example.

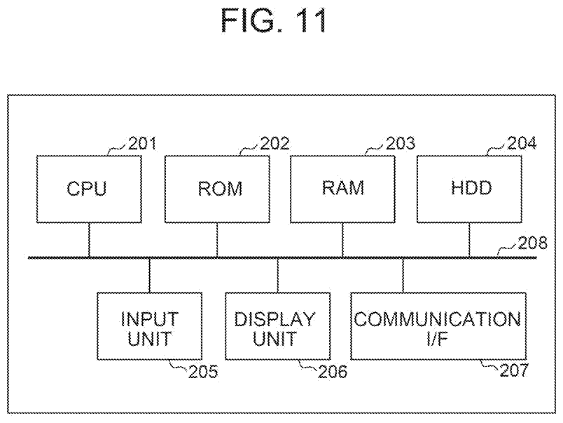

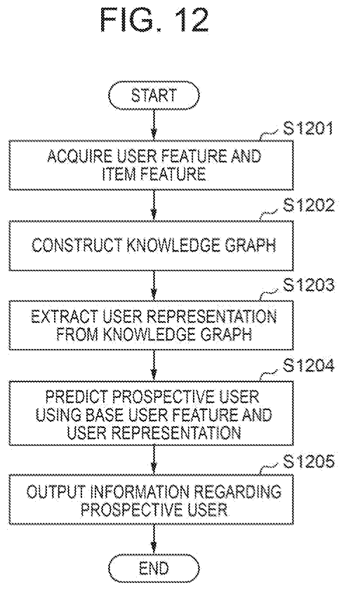

The prospective user prediction unit 105 predicts a user that is predicted to have user features similar to those of a predetermined seed user, as a prospective user (similar user). The seed user is at least one user that has purchased and/or used a given product or service through a web service, and/or that has positively evaluated the product or service through the web service. The seed user is at least one user selected from the user apparatuses 11-1 to 11-N and set. The seed user may be selected and set by the prospective user prediction unit 105. Also, the seed user may be set by an operator through an input operation performed using an input unit (input unit 205 in FIG. 12), may be set in advance in the system, or may be set by any program stored in a storage unit (ROM 202 or RAM 203 in FIG. 11). In the present embodiment, the prospective user is predicted using a prospective user prediction model 111 that has been trained by the training unit 106. The processing for predicting the prospective user will be described later.

The training unit 106 trains the prospective user prediction model 111 and the score prediction model 112 and stores the trained prospective user prediction model 111 and the score prediction model 112 in the learning model storage unit 110. Processing for training each learning model will be described later.

The output unit 107 outputs a user representation extracted by the representation extraction unit 104 and information regarding a prospective user predicted by the prospective user prediction unit 105. The output can be any output processing, and may be output to an external apparatus via the communication I/F (the communication I/F 207 in FIG. 11), or may be display on a display unit (the display unit 206 in FIG. 11).

Procedure for Constructing Knowledge Graph

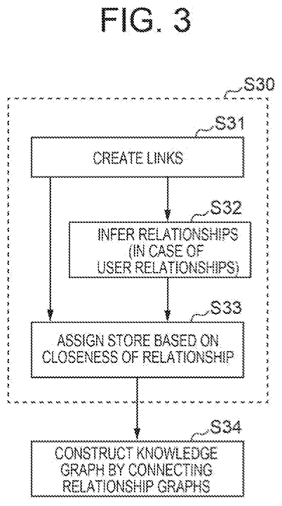

Next, a procedure for creating a knowledge graph according to the present embodiment will be described. The knowledge graph is constituted by a user relationship graph, an item relationship graph, and a user-item relationship graph. FIG. 3 shows a flowchart of the procedure for constructing a knowledge graph that is executed by the graph construction unit 103 according to the present embodiment. First, procedures for creating the user relationship graph, the item relationship graph, and the user-item relationship graph (corresponding to the processing in step S30 in FIG. 3) will be described below.

(1) Procedure for Creating User Relationship Graph

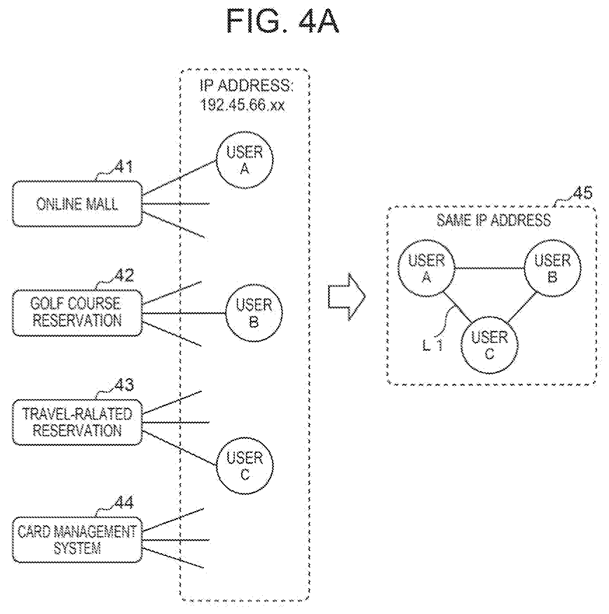

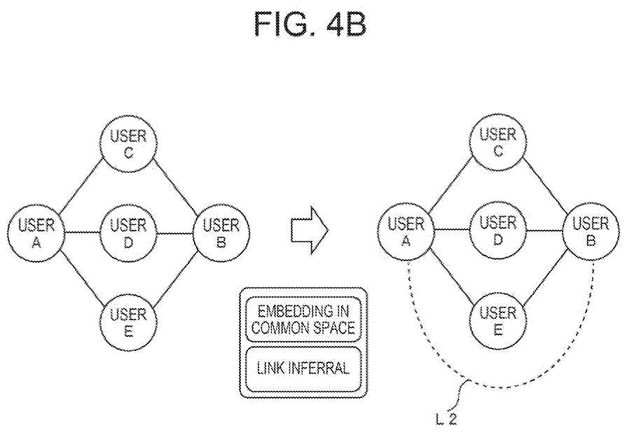

A procedure for creating a user relationship graph will be described. Note that users A to E in the following description are users referred to for the description, and can be users of the user apparatuses 11. Also, the user relationship graph is constituted by connections of user nodes (nodes including identification information of users) circled in FIGS. 4A and 4B, and in the following description, the user nodes are simply referred to as users. Each step of the processing in step S30, with respect to the user relationship graph, in FIG. 3 will be described below.

Step S31: Link Creation

In step S31, the graph construction unit 103 predicts and creates links between a plurality of users.

The processing for creating links will be described with reference to FIGS. 4A and 4B. FIG. 4A is a diagram for illustrating an explicit link, and FIG. 4B is a diagram for illustrating an implicit link. An explicit link is a link created by explicit features held in common by two users (a user pair). An implicit link is a link created as an indirect relationship using explicit links that have already been created, although there is no clear explicit link held in common by the user pair. Thus, links between users are identified by explicit links and implicit links.

FIG. 4A shows an example in which explicit links are created using an IP address of user apparatuses of users as a common feature. FIG. 4A shows an example in which an online mall 41, a golf course reservation service 42, a travel-related reservation service 43, and a card management system 44 exist as web services available to users A to C. In FIG. 4A, four web services are shown, but the number of web services is not limited to a specific number.

The online mall 41 is a shopping mall that is available online (using the Internet). For example, the online mall 41 can provide a wide variety of products and services such as fashion, books, food, concert tickets, and real estate.

The golf course reservation service 42 is operated by a website that provides a service relating to a golf course online, and for example, can provide a search for golf courses, reservations, and lesson information.

The travel-related reservation service 43 is operated by a website that provides various travel services that are available online. The travel-related reservation service 43 can, for example, provide reservations for hotels and travel tours, reservations for airline tickets and rental cars, sightseeing information, information regarding hotels and surrounding areas of the hotels.

The card management system 44 is operated by a website that provides a service related to a credit card issued and managed by a predetermined card management company. The card management system 44 may also provide a service relating to at least one of the online mall 41, the golf course reservation service 42, and the travel-related reservation service 43.

In the example of FIG. 4A, the users A to C use the same IP address (=198.45.66.xx) to use the online mall 41, the golf course reservation service 42, and the travel-related reservation service 43. The information on the IP address can be acquired by the user feature acquisition unit 101.

In such a case, the graph construction unit 103 creates mutual explicit links between the users A to C (e.g., a link L1 between the user A and the user C) with the feature of having the same IP address, as shown in a link state 45. The explicit links are shown by solid lines.

In addition to the example shown in FIG. 4A, explicit links can be created using a feature of user addresses and a feature of credit card numbers used by users as a common feature.

FIG. 4B shows an example of creating an implicit link between users. In the example of FIG. 4B, the user C, the user D, and the user E are connected to the user A by explicit links, and the user C, the user D, and the user E are connected to the user B by explicit links. This kind of link feature (a feature indicating a relationship between links) is embedded in the common feature space, and a link obtained by inferring that a relationship is implicitly constructed between users (nodes) is created (established) as an implicit link. In the example of FIG. 4B, the user A and the user B are not connected by an explicit link, but an implicit link L2 shown by a broken line is created as a result of inferring that there is a relationship in the common feature space. Note that the graph construction unit 103 predicts and creates explicit links between users by performing learning (representation learning, relationship learning, embedding learning, knowledge graph embedding) of a user relationship graph constituted by nodes (users) connected by explicit links. At this time, the graph construction unit 103 may perform the learning based on a known embedding model or its extension, as appropriate.

Step S32: Inferring Relationships Between Links

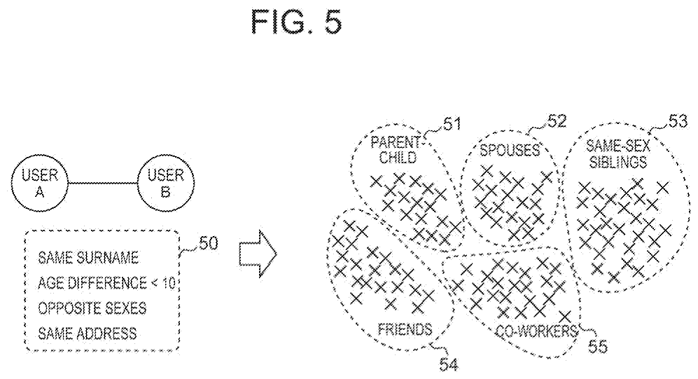

In step S32, the graph construction unit 103 infers relationships between the links predicted and created in step S31. The processing for inferring relationships between links will be described with reference to FIG. 5. FIG. 5 is a diagram for illustrating processing for inferring relationships between links, and shows an example of inferring a relationship of a link between the user A and the user B who are connected by an explicit link.

The graph construction unit 103 treats the pair of users connected by the link created in step S31 as a data point and groups the pair (the data point) into a cluster representing a common type, using various types of information acquired by the user feature acquisition unit 101. The various types of information can be information such as an IP address, an address, a credit card, an age, a sex, or a friend. Also, each cluster can be a cluster having a relationship such as spouses, a parent and child, neighbors, people sharing the same household, co-workers, friends, siblings of the same sex, or siblings of different sexes. In the example of FIG. 5, a pair of users is indicated by an X mark, and a parent-child cluster 51, a spouse cluster 52, a same-sex sibling cluster 53, a friend cluster 54, and a co-worker cluster 55 are shown as clusters into which the pair can be grouped. Note that although five clusters are shown in FIG. 5, the number of clusters is not limited to a specific number.

For example, if the user A and the user B have (share) features 50 of having the same surname, having an age difference of 10 years or less, being of opposite sexes, and having the same address, the graph construction unit 103 can group the pair of the user A and the user B into the cluster (spouse cluster 52) indicating the relationship of husband and wife (spouses).

Step S33: Score Assignment Based on Closeness of Relationship

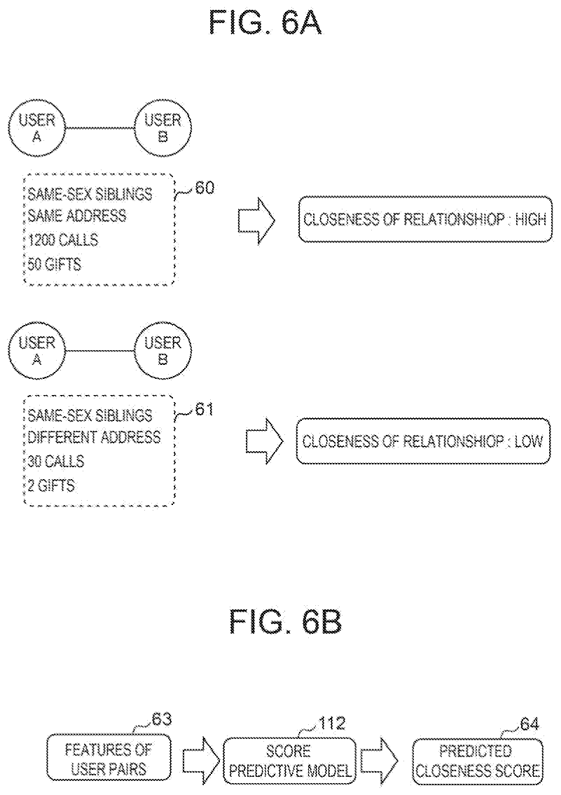

In step S33, the graph construction unit 103 predicts a score based on the closeness of the relationship for the pair inferred in step S32, and assigns the score to the pair. In this embodiment, the score is a numeric value between 0 and 1, but there is no particular limitation on the numeric value that the score can take. FIG. 6A shows a conceptual diagram of a score based on the closeness of the relationship of a user pair (hereinafter referred to as a closeness score).

In the example of FIG. 6A, the closeness of the relationship of the pair of users changes depending on the features that the user A and the user B connected by the explicit link have (share). In the upper part of FIG. 6A, if the relationship between the user A and the user B has features 60 of being same-sex siblings, having the same address, having a call history of 1200 calls, and exchanging gifts 50 times, the closeness of the relationship of the pair of users (i.e., the closeness score) is higher. On the other hand, in the lower part of FIG. 6A, if the relationship between the user A and the user B has features 61 of being same-sex siblings, having different addresses, having a call history of 30 calls, and exchanging two gifts, the closeness of the relationship of the pair of users (i.e., the closeness score) is lower. In this manner, as in the example of FIG. 6A, even if the user A and the user B are same-sex siblings, the closeness of the relationship of the pair differs depending on other features shared by the pair of users. It is observed that pairs with a high closeness score have a close social distance to each other and have a high influence on each other. On the other hand, it is observed that pairs with a low closeness score have a far social distance from each other and do not have a close relationship.

In the present embodiment, a score prediction model 112 is used to predict the closeness score for a user pair. Schematic architecture of the score prediction model 112 is shown in FIG. 6B. The score prediction model 112 is a learning model that receives features 63 of the user pair as input and predicts the closeness score 64 for the features 63.

The score prediction model 112 is, for example, a learning model that performs weak supervised learning, such as a learning model using a convolutional neural network (CNN). In the present embodiment, the score prediction model 112 is a learning model that is trained using closeness scores (0 to 1) assigned to a plurality of features for user pairs as training data, as shown in FIG. 6A. For example, in the training stage, combined data of a closeness score close to 1 set for the features 60 in FIG. 6A and a closeness score close to 0 set for the features 61 is used as training data. The training processing is performed by the training unit 106.

It should be noted that, in the present embodiment, although the closeness score for a user pair is predicted using the score prediction model 112, the graph construction unit 103 may also be configured to predict the score using another method.

Through the above processing, explicit links or implicit links are formed between a plurality of users, closeness scores are assigned for each link, and a user relationship graph is created. A conceptual diagram of the user relationship graph is shown in FIG. 6C. A closeness score predicted as described above is assigned to each user pair.

(2) Procedure for Creating Item Relationship Graph

Next, a procedure for creating an item relationship graph will be described. Similarly to the procedure for creating the user relationship graph, the graph construction unit 103 creates an item relationship graph in accordance with the flowchart of processing for creating a relationship graph in step S30 in FIG. 3. Note that when the item relationship graph is created, the processing in step S32 is not performed.

Step S31: Link Creation

In step S31, the graph construction unit 103 creates links between a plurality of items based on item features 122 stored in the feature storage unit 120. As described above, the item features according to the present embodiment includes an item ID, a genre ID, and a shop ID. That is, one item ID is associated with at least one genre ID and/or shop ID. Note that the genre ID and the shop ID may also be hierarchically configured. For example, the genre may be hierarchically configured, and each level of genre may include a genre ID. Also, the item features are not limited to an item ID, a genre ID, and a shop ID, and may also include other pieces of information (attributes) such as information relating to a brand, color, and properties of an item.

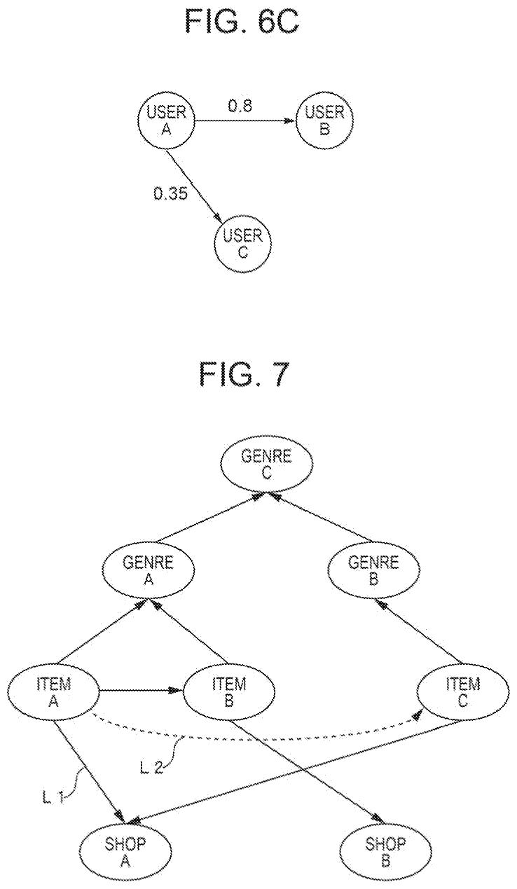

The graph construction unit 103 forms a link between a genre ID and a shop ID that are associated with any item ID, and the any item ID. FIG. 7 shows a conceptual diagram of the item relationship graph. The item relationship graph is constituted by connections of nodes indicating an item ID, a genre ID, or shop ID that are circled in FIG. 7, and in the following description, the nodes are simply referred to as items, genres, or shops.

In FIG. 7, the links connected based on item features are explicit links, and are shown by solid lines (e.g., a link L1 between an item A and a shop A). Also, if the color or property is similar between items (if the similarity is higher than a predetermined threshold), the items can be connected by an explicit link (e.g., a link between the item A and an item B). On the other hand, there are cases where different items are sold in one shop. In FIG. 7, an item A and an item C are sold in a shop A, and therefore are linked to the shop A. Accordingly, the graph construction unit 103 can connect the item A and the item C by an implicit link shown by a broken line (in the example in FIG. 7, a link L2 between the item A and the item C). Note that, by performing learning (representation learning, relationship learning, embedding learning, knowledge graph embedding) of an item relationship graph constituted by nodes (users) that are connected by explicit links, the graph construction unit 103 predicts and creates implicit links between items. At this time, the graph construction unit 103 may perform the learning based on a known embedding model or its extension, as appropriate.

Step S33: Score Assignment Based on Closeness of Relationship

In step S33, the graph construction unit 103 predicts a score (closeness score) based on a closeness of the relationship of each pair in the links created in step S31, and assigns the score to the pair. In FIG. 7, when the item A is sold (traded) better than the item B in the genre A, a high score is assigned to a pair of the item A and the genre A, for example. Also, when it is determined that the probability that the item A belongs to the genre A is high, a high score based on that probability is assigned to the pair of the item A and the genre A. Also, when the similarity between any items is high, a high score is assigned to a pair of the items.

The graph construction unit 103 may also predict a closeness score assigned to each pair using the aforementioned score prediction model 112. When the score prediction model 112 is used, training is performed using, as training data, closeness scores (0 to 1) assigned to features, such as the number of transactions and the similarity between items, of any pairs between items, genres, and shops (see FIG. 6B). For example, in the training stage, combined data of a closeness score close to 1 set for a feature of the number of transactions being large or the similarity being high, and a closeness score close to 0 set for the feature of the number of transactions being small or the similarity being low is used as training data. The training processing is performed by the training unit 108. As a result of assigning scores, the score of each pair can be represented as a numeric value, similarly to the user relationship graph shown in FIG. 6C.

(3) Procedure for Creating User-Item Relationship Graph

Next, a procedure for creating a user-item relationship graph will be described. Similarly to the procedure for creating the user relationship graph, the graph construction unit 103 creates a user-item relationship graph in accordance with the flowchart of processing for creating a relationship graph in step S30 in FIG. 3. Note that when the user-item relationship graph is created, the processing in step S32 is not performed.

Step S31: Link Creation

In step S31, the graph construction unit 103 creates links between any user and one or more items based on the user features 121 stored in the feature storage unit 120. First, the graph construction unit 103 acquires user features related to items for each user such as a purchase history, a search history, or a viewing history (including a click history) from the user features 121 stored in the feature storage unit 120. The graph construction unit 103 creates a user-item relationship graph for each user using user features related to the items for the user.

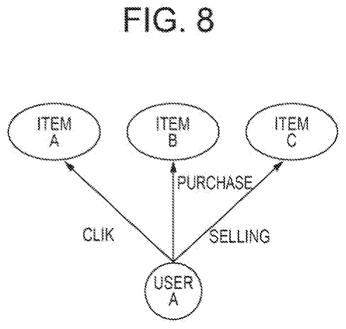

FIG. 8 shows a conceptual diagram of the user-item relationship graph. The user-item relationship graph is constituted by connections of user nodes and nodes indicating item IDs that are circled in FIG. 7, and in the following description, the user nodes and the nodes indicating item IDs are simply referred to as users and items.

In FIG. 8, a link is formed between a user A and an item A based on a click history performed on the item A by the user A. The click history of the item A includes a click on a predetermined screen area (e.g., button, photograph, icon) for the item A. Also, a link is formed between the user A and an item B based on a history of purchase of the item B made by the user A. Also, a link is formed between the user A and an item C based on a history of selling the item C made by the user A. Note that, in FIG. 8, the user A and the items are connected by explicit links, but an indirect connection from the user A to any item may also be represented by an implicit link. Also, a link may be formed between a user and an item based on a history of distribution of advertisement of the item to the user. Note that the graph construction unit 103 predicts and creates implicit links between users and items by performing learning (representation learning, relationship learning, embedding learning, knowledge graph embedding) of a user-item relationship graph constituted by nodes (users) connected by explicit links. At this time, the graph construction unit 103 may perform the learning based on a known embedding model or its extension, as appropriate.

Step S33: Score Assignment Based on Closeness of Relationship

In step S33, the graph construction unit 103 predicts a score (closeness score) based on the closeness of the relationship for each pair connected by a link created in step S31, and assigns the score to the pair. The graph construction unit 103 may predict the closeness score for a pair of a user and an item, based on a history related to the transaction of items such as the aforementioned click history, purchase history, selling history, and advertisement distribution history. For example, it can be said that the distance between a user and an item is closer when the user has actually purchased the item than when the user merely clicked the item. Therefore, in the example in FIG. 8, a higher score is assigned to the pair of the user A and the item B than the pair of the user A and the item A. Also, the relationship between a user and an item is considered to be closer when the user sells the item than when the user performs click operation, and in the example in FIG. 8, a higher score is assigned to the pair of the user A and the item C than the pair of the user A and the item A. Also, when a user has not performed clicking or purchasing of an item, even if an advertisement of the item is distributed to the user a plurality of times, a low score may be assigned to the pair of the user and the item, for example.

The graph construction unit 103 may also predict the closeness score for each pair using the aforementioned score prediction model 112. When the score prediction model 112 is used, training is performed using closeness scores (0 to 1) assigned to features of pairs of users and items as training data (see FIG. 6B). For example, in the training stage, combined data of a closeness score close to 1 set for a feature of purchasing and a closeness score close to 0 set for a feature of clicking is used as training data. The training processing is performed by the training unit 106. As a result of assigning scores, the score of each pair can be represented as a numeric value, similarly to the user relationship graph shown in FIG. 6C.

Note that in FIG. 8, a user-item relationship graph is defined as pairs of a user and an item, but when a user has a history of clicking, purchasing, or selling a specific item, a link is formed between the user and a genre (genre ID). Also, a closeness score is assigned to the feature shared by the pair.

(4) Procedure for Constructing Entire Knowledge Graph

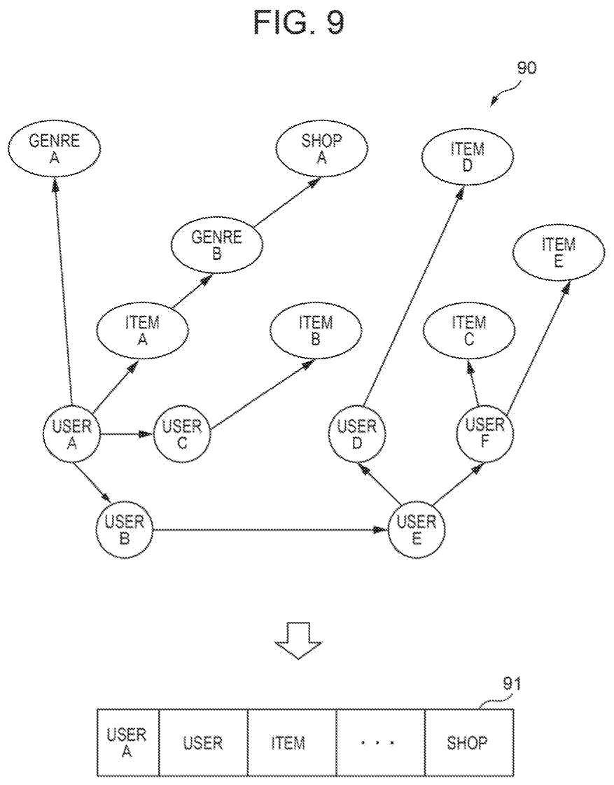

After the user relationship graph, user-item relationship graph, and item relationship graph are created using the procedures (1) to (3) described above, in step S34 in FIG. 3, the graph construction unit 103 constructs (creates) the entire knowledge graph by connecting these graphs. In the upper part of FIG. 9, a conceptual diagram (knowledge graph 90) of the knowledge graph is shown. The graph construction unit 103 connects the created user relationship graph, user-item relationship graph, and item relationship graph using nodes that are in common between these graphs as connection points. Next, the graph construction unit 103 constructs the knowledge graph by performing streamlining such as deleting duplicate links. Although not shown in FIG. 9, closeness scores indicating closeness between nodes are assigned to inter-nodes between nodes (users, items, genres, and the like). Note that the closeness score may be represented by the length of an arrow. Also, although not shown in FIG. 9, each user includes user features, or user features are connected to the user as a node. Note that the nodes such as users, items, and genres correspond to entities (head entities or tail entities) in a knowledge graph, and the pairs and links correspond to relations.

The graph construction unit 103 may construct the entire knowledge graph by connecting the fact-based user relationship graph, item relationship graph, and user-item relationship graph that are constituted by nodes connected by explicit links and the explicit links. Also, the graph construction unit 103 may construct the entire knowledge graph by connecting some relationship graphs of the user relationship graph, item relationship graph, and user-item relationship graph that are fact-based relationship graphs and are constituted by nodes connected by explicit links and the explicit links and the remaining relationship graphs of the user relationship graph, item relationship graph, and user-item relationship graph that are constituted by nodes connected by explicit links, the explicit links, nodes connected by implicit links, and the implicit links. That is, in the entire knowledge graph, at least one of the user relationship graph, item relationship graph and user-item relationship graph may not include implicit links. Also, the graph construction unit 103 may predict and create implicit links between nodes by embedding the created knowledge graph into a feature space (vector space). That is, the graph construction unit 103 may predict and create implicit links from a knowledge graph constituted only by explicit links. Note that the embedded representations (vector representations) of entities such as user representations may also be extracted (acquired) based on the entire knowledge graph in which at least one of the user relationship graph, item relationship graph, and user-item relationship graph does not include implicit links.

Procedure for Extracting User Representation

Next, a procedure for extracting a user representation according to the present embodiment will be described. The representation extraction unit 104 extracts a user representation for any user from a knowledge graph constructed by the graph construction unit 103. Specifically, the representation extraction unit 104 embeds the knowledge graph in a feature space (vector space), and learns embedded representations (vector representations) of nodes (entities) and links (relations) in the feature space. The representation extraction unit 104 performs learning (representation learning, relationship learning, embedding learning) of the knowledge graph, and extracts (acquires) an embedded representation (low-dimensional vector representation) of any user as the user representation (user feature vector).

The representation extraction unit 104 may adopt a translation-based model that performs learning based on distances between vector representations of entities such as TransE, TransD, and RotatE, as an embedding model to be used for learning of (embedding) a knowledge graph. Also, the representation extraction unit 104 may adopt an embedding-projection model that performs learning by mapping vector representations of entities such as TransH, TransR, and STransE to a vector space that is different for each relation. The representation extraction unit 104 may also adopt a model that performs learning using conversion of vector representations such as CompIEx into a complex number space. The representation extraction unit 104 may also adopt a model that performs learning using a convolutional neural network (NN) that includes an NN such as ConvE, ConvR, or R-GCN. Also, the representation extraction unit 104 may adopt a model that uses an attention mechanism such as a knowledge graph attention network (KGAT), and adopt a known model such as TorusE and its extension, as appropriate. Note that the representation extraction unit 104 may use regularization (L1 regularization, L2 regularization, or the like) when learning of the knowledge graph is performed, as appropriate.

Features of nodes and closeness scores assigned to inter-nodes (pairs, links) may be reflected on the user representation. Here, the representation extraction unit 104 may perform learning (embedding of knowledge graphs) of vector representations of nodes and links while performing weighting on the vector representations for links (relations) between nodes based on closeness scores between nodes. Also, the representation extraction unit 104 may extract a vector representation of an entity such as any user, by selectively or exclusively learning vector representations of links whose closeness scores exceed or are lower than a predetermined threshold and of nodes connected through the links. Here, the nodes at least include nodes corresponding to an entity such as any user. Also, the representation extraction unit 104 may extract a vector representation of an entity such as any user, by selectively or exclusively learning vector representations of nodes and links in the N^{th} (N>1) neighbor of the node corresponding to the entity such as the user. In this way, the calculation load can be reduced by screening targets to be learned according to the closeness score.

A conceptual diagram (user representation 91) of a user representation (node representation) extracted for the user A is shown in the lower part in FIG. 9. In the user representation 91, pieces of information regarding one or more users, items, genres, and shops that are connected to the user A by implicit and explicit links are reflected on one user representation. Closeness scores of nodes (item, genre, and the like) connected to the user A may also be represented in the user representation. That is, the user representation of the user A may correspond to a neighboring representation on which closenesses of relationships between the user A and the nodes are reflected.

Note that the representation extraction unit 104 may also extract an item representation (node representation) for any item from the knowledge graph constructed by the graph construction unit 103.

Processing for Predicting Prospective user

Next, processing for predicting a prospective user according to the present embodiment will be described. The prospective user prediction model 111 is a learning model for predicting, as a prospective user, a user having a similar feature as a seed user. The seed user is a user that has purchased and/or used a given product or service through a web service, and/or a user that has positively evaluated the product or service through the web service.

The prospective user prediction model 111 is a learning model for machine learning based on XGBoost, for example. In the training stage, the training unit 106 trains the prospective user prediction model 111 using user features of a seed user (positive user), user features of users (negative users) other than the seed user, and user representations of these users. The user features are base user features, and include a purchase history (information regarding genre and type of a product, or the like) in the web service. The demographic information and the purchase history may include a plurality of subdivided features. Note that the user features are not limited to demographic information and a purchase history, and may also include other features such as a point status (number of points that can be used), a point feature (information regarding a point transaction such as information regarding points acquired from an offline shop or an online shop, points used, and the like).

The training unit 106 verifies and tunes (adjusts) hyper parameters (parameters for controlling the behavior of the prospective user prediction model 111) by grid search and cross validation. Because XGBoost is a tree (decision tree)-based model, the prospective user prediction model 111 can generate a result that shows how the input data (user features) affects the output of the model. This makes it possible to verify which of the user features (combinations of subdivided features) are highly affected by the seed user, for example.

The trained prospective user prediction model 111 is configured to output the likelihood (likelihood of being a prospective user) that a user has user features similar to those of the seed user. The likelihood is represented by a numeric value from zero to one, where the largest likelihood is one, for example. Here, when the threshold is set to 0.5, the prospective user prediction unit 105 can predict (determine) that a user having a likelihood larger than 0.5 is a prospective user (that is, a potential user having features similar to those of the seed user). Note that there may also be a plurality of seed users, and in this case, the prospective user prediction unit 105 can predict a user having user features similar to those of the users included in the plurality of seed users (seed user group (model user group)), as a prospective user.

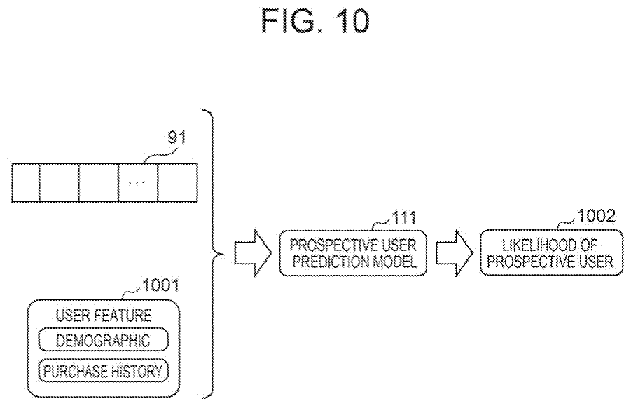

In the present embodiment, for any user, the prospective user prediction unit 105 inputs a user representation extracted by the representation extraction unit 105 and base user features to the prospective user prediction model 111, and predicts whether or not the user is a prospective user. FIG. 10 is a diagram for describing prospective user prediction processing according to the present embodiment. When a user A is set as any user (target user), the prospective user prediction unit 105 inputs base user features 1001 of the user A and a user representation 91 extracted by the representation extraction unit 104 to the prospective user prediction model 111, and predicts whether or not the user A is a prospective user. Specifically, the prospective user prediction unit 105 predicts and outputs the likelihood (likelihood 1002 of a prospective user) that the user A has user features similar to those of the seed user, from the user features 1001 of the user A and the user representation 91.

Hardware Configuration of Information Processing Apparatus 10

FIG. 11 is a block diagram showing an example of a hardware configuration of the information processing apparatus 10 according to this embodiment.

The information processing apparatus 10 according to the present embodiment can be implemented also on any one or more computers, mobile apparatuses, or other processing platforms.

With reference to FIG. 11, an example is shown in which the information processing apparatus 10 is implemented on a single computer, but the information processing apparatus 10 according to the present embodiment may be implemented on a computer system including a plurality of computers. The plurality of computers may be connected so as to be capable of mutual communication through a wired or wireless network.

As shown in FIG. 11, the information processing apparatus 10 may include a CPU 201, a ROM 202, a RAM 203, an HDD 204, an input unit 205, a display unit 206, a communication IN 207, and a system bus 208. The information processing apparatus 10 may include an external memory.

The CPU (Central Processing Unit) 201 performs overall control of operations in the information processing apparatus 10, and controls each constituent unit (202 to 207) via the system bus 208, which is a data transmission path.

The ROM (Read Only Memory) 202 is a non-volatile memory that stores control programs and the like needed for the CPU 201 to execute processing. Note that the program may also be stored in a non-volatile memory such as the HDD (Hard Disk Drive) 204 or an SSD (Solid State Drive), or an external memory such as a detachable storage medium (not shown).

The RAM (Random Access Memory) 203 is a volatile memory and functions as a main memory, a work area, and the like of the CPU 201. That is, during execution of processing, the CPU 201 executes various functional operations by loading necessary programs and the like from the ROM 202 to the RAM 203, and executing the programs and the like. The learning model storage unit 110 and the feature storage unit 120 shown in FIG. 2 can be constituted by the RAM 203.

The HDD 204 stores various types of data, various types of information, and the like that are needed when the CPU 201 performs processing using a program. Also, the HDD 204 stores various types of data, various types of information, and the like obtained by the CPU 201 performing processing using a program or the like.

The input unit 205 is constituted by a keyboard or a pointing apparatus such as a mouse.

The display unit 206 is constituted by a monitor such as a liquid crystal display (LCD). The display unit 206 may also function as a GUI (Graphical User Interface) due to being included in combination with the input unit 205.

The communication IN 207 is an interface that controls communication between the information processing apparatus 10 and an external apparatus.

The communication I/F 207 provides an interface with a network and executes communication with an external apparatus via the network. Various types of data, various types of parameters, and the like are transmitted and received to and from the external apparatus via the communication I/F 207. In this embodiment, the communication I/F 207 may execute communication via a wired LAN (Local Area Network) or a dedicated line conforming to a communication standard such as Ethernet (registered trademark). However, the network that can be used in this embodiment is not limited thereto, and may also be constituted by a wireless network. This wireless network includes a wireless PAN (Personal Area Network) such as Bluetooth (registered trademark), ZigBee (registered trademark), and UWB (Ultra Wide Band). This wireless network also includes a wireless LAN (Local Area Network) such as Wi-Fi (Wireless Fidelity) (registered trademark) and a wireless MAN (Metropolitan Area Network) such as WiMAX (registered trademark). Furthermore, the wireless network includes a wireless WAN (Wide Area Network) such as LTE/3G, 4G, and 5G. Note that it is sufficient that the network connects the apparatuses such that communication is possible therebetween and is capable of communication, and the standard, scale, and configuration of communication is not limited to the above.

The function of at least some of the elements of the information processing apparatus 10 shown in FIG. 2 can be realized by the CPU 201 executing a program. However, the function of at least some of the elements of the information processing apparatus 10 shown in FIG. 2 may also operate as dedicated hardware. In this case, the dedicated hardware operates based on control performed by the CPU 201.

Hardware Configuration of User Apparatus 11

The hardware configuration of the user apparatus 11 shown in FIG. 1 may be the same as that shown in FIG. 11. That is, the user apparatus 11 can include the CPU 201, the ROM 202, the RAM 203, the HDD 204, the input unit 205, the display unit 206, the communication I/F 207, and the system bus 208. The user apparatus 11 can display various types of information provided by the information processing apparatus 10 on the display unit 206 and perform processing corresponding to an input operation received from the user via the GUI (constituted by the input unit 205 and the display unit 206).

Flow of Processing

FIG. 12 shows a flowchart of processing executed by the information processing apparatus 10 according to the present embodiment. The processing shown in FIG. 12 can be realized by the CPU 201 of the information processing apparatus 10 loading a program stored in the ROM 202 or the like to the RAM 203 and executing the loaded program. The information processing system shown in FIG. 1 will be referred to for the description of FIG. 12. The prospective user prediction model 111 and the score prediction model 112 trained by the training unit 106 are stored in the learning model storage unit 110.

In step S1201, the user feature acquisition unit 101 acquires the user features of the users from the user apparatuses 11-1 to 11-N and stores the acquired user features in the feature storage unit 120 as the user features 121. Also, the item feature acquisition unit 102 acquires, from a predetermined database, features (attributes) of items based on registration information and a transaction history in various web services, and stores the acquired features in the feature storage unit 120 as item features 122. The processing of step S1201 may also be processing for acquiring (collecting) user features and item features of a predetermined past period.

In step S1202, the graph construction unit 103 constructs a knowledge graph. The procedure for constructing the knowledge graph is as described above with reference to FIG. 3.

In step S1203, the representation extraction unit 104 extracts a user representation for any user from the knowledge graph created in step S1202. The procedure for extracting the user representation is as described above with reference to FIG. 9.

In step S1204, the prospective user prediction unit 105 predicts the likelihood that the user is a prospective user having features similar to those of a predetermined seed user. In the present embodiment, for the any user, the prospective user prediction unit 105 predicts and outputs the likelihood that the user is a user having features similar to those of the seed user (likelihood of a prospective user) by inputting base user features of the user and a user representation of the user into the prospective user prediction model 111, as shown in FIG. 10.

The prospective user prediction unit 105 may also select and set, out of the user apparatuses 11-1 to 11-N, a plurality of users (target user group) other than the seed user (or, seed user group). Also, the prospective user prediction unit 105 can predict, from the target user group, prospective users having features similar to those of the predetermined seed user as a prospective user group (similar user group). In this case, the prospective user prediction unit 105 predicts the prospective user group by inputting, for each user of the target user group, base user features of the user and a user representation of the user into the prospective user prediction model 111. Also, when there are a plurality of seed users (seed user group), the prospective user prediction unit 105 can predict, from the target user group, users having features similar to those of users included in the seed user group as a prospective user group.

In step S1205, the output unit 107 outputs a result regarding the likelihood of a prospective user predicted in step S1204. For example, when processing in steps S1203 and S1204 is performed with respect to a plurality of users, the output unit 107 can generate information regarding the prospective user group predicted from the plurality of users, and output the information to an external apparatus (not shown).

As described above, the information processing apparatus according to the present embodiment creates a user relationship graph, an item relationship graph, and a user-item relationship graph from user features of a plurality of users and features of a plurality of items, and creates a knowledge graph using these relationship graphs. In the knowledge graph, with respect to any user, all users other than the any user and items (including genres, shops, and the like) that are related to the any user are linked, and the knowledge graph is expected to be utilized in a platform business.

Also, the information processing apparatus according to the present embodiment creates, for any user, a user representation that represents all users other than the any user and items that are related to the user, from the knowledge graph. The user representation is a representation in which one user is associated with features (attributes) of all other users and items. That is, the user representation is not a separate representation of any user with respect to each of other users and items, and is a representation configured by containing complex relationships with other users and items. Accordingly, the linkage of any user to other users and items can be handled as one representation, and it is possible to obtain an advantageous effect that the computation processing amount can be reduced when the user representation is used for any prediction processing to be performed for a platform business.

Moreover, the information processing apparatus according to the present embodiment predicts, using a user representation and user features for any user, whether or not the user has features similar to those of a predetermined seed user (likelihood of prospective user). As a result of using the user representation in addition to the user features, prediction in which users' preferences are well considered can be performed, and the accuracy of prediction can be improved. Also, using information regarding a prospective user obtained by prediction, marketing focusing on a narrow target can be performed.

### Second Embodiment

Next, a second embodiment will be described. An information processing system according to the present embodiment may be configured similarly to the first embodiment, as shown in FIG. 1. The differences from the first embodiment will be described below, and similar configurations and features will not be described.

Functional Configuration of Information Processing Apparatus 10

An information processing apparatus 10 according to the present embodiment, first, acquires various user features from user apparatuses 11-1 to 11-N, and also acquires features regarding items from a predetermined database. Then, the information processing apparatus 10 creates a graph neural network (GNN), as a graph network (graph), from the acquired features, and extracts a user representation for any user from the GNN. Moreover, the information processing apparatus 10 predicts, using the user representation, a prospective user that has user features similar to those of a predetermined seed user (e.g., whose likelihood of purchasing a predetermined item similarly to the seed user is high).

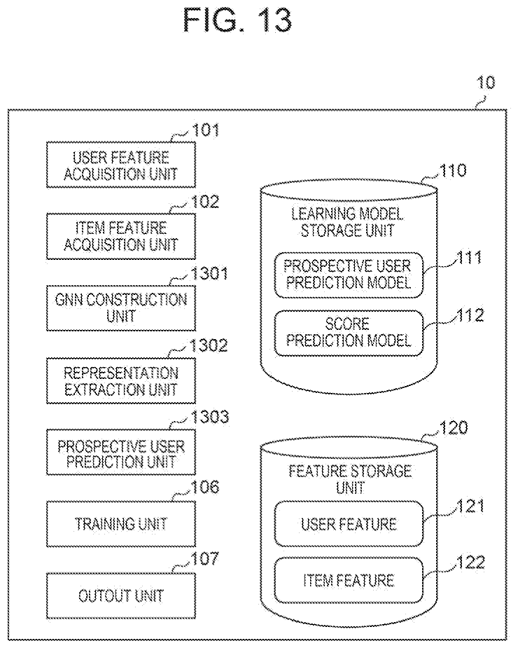

FIG. 13 shows an example of a functional configuration of the information processing apparatus 10 according to the present embodiment.

The information processing apparatus 10 shown in FIG. 13 includes a user feature acquisition unit 101, an item feature acquisition unit 102, a GNN construction unit 1301, a representation extraction unit 1302, a prospective user prediction unit 1303, a training unit 1304, an output unit 107, a learning model storage unit 110, and a feature storage unit 120. The learning model storage unit 110 stores a prospective user prediction model 113 and a score prediction model 112. Also, the feature storage unit 120 is configured to store user features 121 and item features 122.

The GNN construction unit 1301 creates a GNN based on user features, item features, and tasks. The procedure of constructing the GNN will be described later.

The representation extraction unit 1302 extracts a user representation for any user from the GNN constructed by the GNN construction unit 1301. Also, the representation extraction unit 1302 may also extract an item representation for any item from the GNN. The processing for extracting the user representation (or, item representation) will be described later.

The prospective user prediction unit 1303 predicts a group of users, as prospective users, that are predicted to have user features similar to those of a predetermined seed user. In the present embodiment, the prospective users are predicted using a prospective user prediction model 113 that has been trained by a training unit 106. The processing for predicting the prospective users will be described later.

Procedure for Constructing GNN

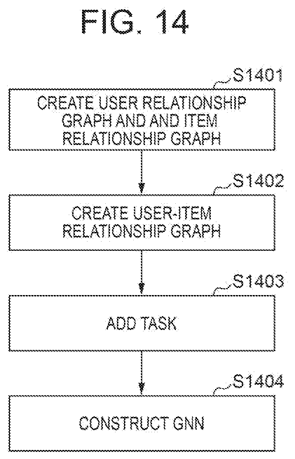

Next, a procedure for constructing a GNN according to the present embodiment will be described. FIG. 14 shows a flowchart of a procedure for constructing a GNN that is executed by the GNN construction unit 1301 according to the present embodiment. First, in step S1401, the GNN construction unit 1301 creates a user relationship graph according to the procedure for creating the user relationship graph that has been described in the first embodiment. Also, the GNN construction unit 1301 creates an item relationship graph according to the procedure for creating the item relationship graph that has been described in the first embodiment.

In step S1402, the GNN construction unit 1301 creates a relationship graph (user-item relationship graph) between a plurality of users (user nodes) and a plurality of items (item nodes), based on the user features 121 stored in the feature storage unit 120. Specifically, first, the GNN construction unit 1301 acquires, from the user features 121 stored in the feature storage unit 120, user features of each user related to items such as a purchase history, a search history, and a viewing history (including a click history) of the user. Next, the GNN construction unit 1301 creates a user-item relationship graph using the user features of each user related to the items. For example, the GNN construction unit 1301 forms, for any user, edges (relationship between nodes, relation) for one or more items regarding which a purchase history, a search history, or a viewing history is present.

Next, in step S1403, the GNN construction unit 1301 sets (defines) a plurality of tasks (task nodes) representing classifications of a plurality of items included in the user-item relationship graph, and adds the task nodes to the graph. The tasks are each one classification of a marketing target, and may be information indicating a brand name of an item, a name of an area in which the item is sold, and a name of an agent that handles the item, for example. In step S1404, the GNN construction unit 1301 trains the GNN, and constructs the GNN by assembling edges between nodes.

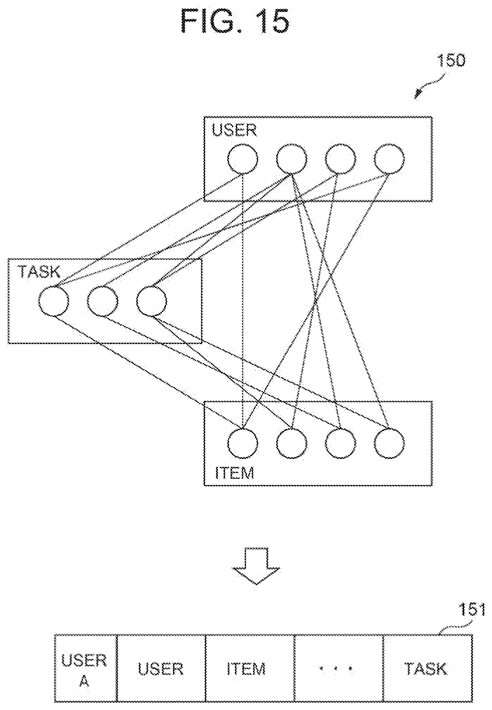

A conceptual diagram (GNN 150) of the GNN is shown in the upper part in FIG. 15. In the GNN 150, in addition to edges between a plurality of user nodes and a plurality of item nodes, edges with a plurality of task nodes are added. The GNN construction unit 1301 acquires relations between the plurality of user nodes and the plurality of task nodes and relations between the plurality of item nodes and the plurality of task nodes from the user features and the item features, and trains the GNN using the acquired relations.

Procedure for Extracting User Representation

Next, a procedure for extracting a user representation according to the present embodiment will be described. The representation extraction unit 1302 extracts a user representation for any user from a GNN constructed by the GNN construction unit 1301. Specifically, the representation extraction unit 1302 embeds the GNN in a common feature space (vector space), and learns embedded representations (vector representations) of nodes (entities) and edges (relations) in the feature space. Learning (representation learning, relationship learning, embedding learning) of the graph network indicated by the GNN is performed, and an embedded representation (low-dimensional vector representation) of any user is extracted (acquired) as the user representation (user feature vector).

A conceptual diagram (user representation 151) of a user representation extracted for a user A is shown in the lower part in FIG. 15. In the user representation 151, in addition to pieces of information regarding one or more users, items, genres, shops, and the like that are related to the user A, information regarding a task (e.g., brand name) is reflected on one user representation.

Note that the representation extraction unit 104 may also extract an item representation regarding any item from the GNN constructed by the GNN construction unit 1301.

Processing for Predicting Prospective user

Next, processing for predicting a prospective user according to the present embodiment will be described. The prospective user prediction model 113 is a learning model for predicting, as a prospective user, a user having features similar to those of a seed user. The seed user is a user that has purchased and/or used a given product or service through a web service, and/or a user that has positively evaluated the product or service through the web service.

The prospective user prediction model 113 is a learning model based on XGBoost, for example. In the training stage, the training unit 106 trains the prospective user prediction model 113 using user features of a seed user, user features of users (negative users) other than the seed user, and user representations of these users. The user features are base user features, (demographic information and purchase history), similarly to the first embodiment.

The training unit 106 verifies and tunes (adjusts) hyper parameters (parameters for controlling the behavior of the prospective user prediction model 113) by grid search and cross validation. Because XGBoost is a tree (decision tree)-based model, the prospective user prediction model 113 can generate a result that shows how the input data (user features) affects the output of the model. This makes it possible to verify which of the user features (combinations of subdivided features) are highly affected by the seed user, for example.

The trained prospective user prediction model 113 is configured to output the likelihood (likelihood of a prospective user) that a user has user features similar to those of the seed user. The likelihood is represented by a numeric value from zero to one, where the largest likelihood is one, for example. Here, when the threshold is set to 0.5, the prospective user prediction unit 1303 can predict (determine) that a user having a likelihood larger than 0.5 is a prospective user (that is, a potential user having features similar to those of the seed user).

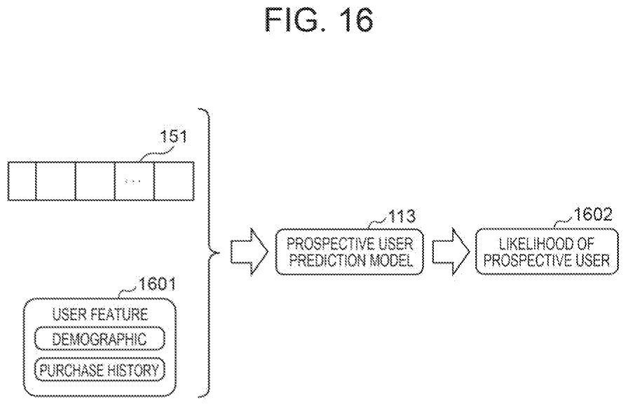

In the present embodiment, for any user, the prospective user prediction unit 1303 inputs a user representation extracted by the representation extraction unit 1302 and base user features to the prospective user prediction model 113, and predicts whether or not the user is a prospective user. FIG. 16 is a diagram for describing prospective user prediction processing according to the present embodiment. When a user A is set as any user (target user), the prospective user prediction unit 1303 inputs base user features 1601 of the user A and a user representation 151 extracted by the representation extraction unit 1302 to the prospective user prediction model 113, and predicts whether or not the user A is a prospective user. Specifically, the prospective user prediction unit 1303 predicts and outputs the likelihood (likelihood 1602 of a prospective user) that the user A has user features similar to those of the seed user, from the user features 1601 of the user A and the user representation 151.

Flow of Processing

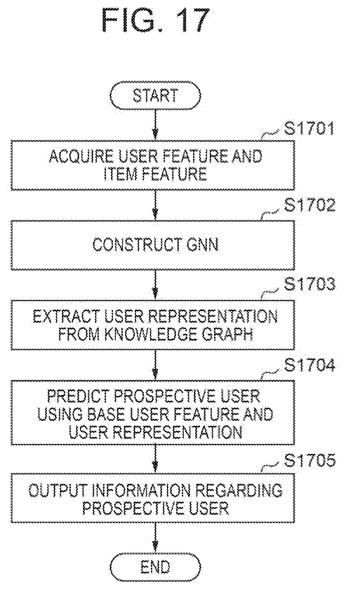

FIG. 17 shows a flowchart of processing executed by the information processing apparatus 10 according to the present embodiment. The processing shown in FIG. 17 can be realized by a CPU 201 of the information processing apparatus 10 loading a program stored in a ROM 202 or the like to a RAM 203 and executing the loaded program. The information processing system shown in FIG. 1 will be referred to for the description of FIG. 17. The prospective user prediction model 113 and the score prediction model 112 trained by the training unit 106 are stored in the learning model storage unit 110.

The processing in step S1701 is similar to the processing in step S1201 in FIG. 12. In step S1702, the GNN construction unit 1301 constructs a GNN. The procedure for constructing the GNN is as described above with reference to FIG. 14.

In step S1703, the representation extraction unit 1302 extracts a user representation for any user from the GNN created in step S1702. The procedure for extracting the user representation is as described above with reference to FIG. 16.

In step S1704, the prospective user prediction unit 1303 predicts the likelihood that any user is a prospective user having features similar to those of a predetermined seed user. In the present embodiment, for the any user, the prospective user prediction unit 1303 predicts and outputs the likelihood that the user is a user having features similar to those of the seed user (likelihood of a prospective user) by inputting base user features of the user and a user representation of the user into the prospective user prediction model 113, as shown in FIG. 16.

The prospective user prediction unit 1303 may also select and set, out of the user apparatuses 11-1 to 11-N, a plurality of users (target user group) other than the seed user (or, seed user group). Also, the prospective user prediction unit 1303 can predict, from the target user group, prospective users having features similar to those of the predetermined seed user as a prospective user group (similar user group). In this case, the prospective user prediction unit 1303 predicts the prospective user group by inputting, for each user of the target user group, base user features of the user and a user representation of the user into the prospective user prediction model 113. Also, when there are a plurality of seed users (seed user group), the prospective user prediction unit 1303 can predict, from the target user group, users having features similar to those of users included in the seed user group as a prospective user group.

In step S1705, the output unit 107 outputs a result regarding the likelihood of the prospective user predicted in step S1704. For example, when processing in steps S1703 and S1704 is performed with respect to a plurality of users, the output unit 107 can generate information regarding the prospective user group predicted from the plurality of users, and output the information to an external apparatus (not shown).

As described above, the information processing apparatus according to the present embodiment creates a GNN from user features of a plurality of users, features of a plurality of items, and a plurality of tasks that are defined as one classification of the items. In the GNN, with respect to any user, all users other than the any user and items (including genres, shops, and the like) that are related to the any user, and tasks are connected by edges, and the GNN is expected to be utilized in a platform business.

Also, the information processing apparatus according to the present embodiment creates, for any user, a user representation that represents all users other than the any user, items, and tasks that are related to the user, from the GNN. The user representation is a representation in which one user is associated with features (attributes) of all other users and items, and tasks. That is, the user representation is not a separate representation of any user with respect to each of other users and items, and is a representation configured by containing complex relationships with other users, items, and tasks. Accordingly, the linkage of any user to other users, items, and tasks can be handled as one representation, and it is possible to obtain an advantageous effect that the computation processing amount can be reduced when the user representation is used for any prediction processing to be performed for a platform business.

Moreover, the information processing apparatus according to the present embodiment predicts, using a user representation and user features for any user, whether or not the user has features similar to those of a predetermined seed user (likelihood of prospective user). As a result of using the user representation including tasks in addition to the user features, prediction in which users' preferences are well considered can be performed, and the accuracy of prediction can be improved. Also, marketing focusing on a narrow target can be performed using information regarding a prospective user obtained by prediction. For example, when the task is set to a brand name, a preference of any user regarding brands is clarified, and for the user, marketing focusing on the preferred brand can be deployed.

It should be noted that although specific embodiments have been described above, the embodiments are merely examples, and are not intended to limit the scope of the present invention. The apparatuses and methods described in the present specification can be embodied in forms other than those described above. Also, the above-described embodiments can be subjected to omission, replacement, and modification as appropriate without departing from the scope of the present invention. Modes obtained through such omission, replacement, and modification are encompassed in the description of the claims and the range of equivalency thereto, and belong to the technical scope of the present invention.

1. An information processing apparatus comprising:
a selection unit configured to select, from a plurality of users, a model user group and a target user group that is different from the model user group;
a generation unit configured to generate, for each user of the target user group, a user representation representing relationships with the plurality of users and the plurality of items; and
a prediction unit configured to predict, based on the user representation, one or more users that have features similar to those of users included in the model user group, from the target user group, as a similar user group.

2. The information processing apparatus according to claim 1, further comprising
a user feature acquisition unit configured to acquire factual features for each user of the plurality of users as user features,
wherein the prediction unit predicts the similar user group based on the user features of the target user group and the user representations.

3. The information processing apparatus according to claim 1, further comprising
a construction unit configured to construct a graph representing mutual relationships between the plurality of users and the plurality of items,
wherein the generation unit generates the user representations from the graph.

4. The information processing apparatus according to claim 3, further comprising
an item feature acquisition unit configured to acquire features regarding a plurality of items as item features,
wherein the construction unit constructs the graph based on the user features of the plurality of users and the item features.

5. The information processing apparatus according to claim 4, wherein the construction unit constructs a first relationship that is a relationship between the plurality of users, a second relationship that is a relationship between the plurality of items, and a third relationship that is a relationship between the plurality of users and the plurality of items, based on the user features of the plurality of users and the item features, and constructs the graph using the first relationship, the second relationship, and the third relationship.

6. The information processing apparatus according to claim 4, further comprising
a task setting unit configured to set a plurality of tasks representing classifications of the plurality of items from the item features,
wherein the construction unit constructs, as the graph, a graph network representing mutual relationships between the plurality of users, the plurality of items, and the plurality of tasks, based on the user features of the plurality of users and the item features.

7. The information processing apparatus according to claim 6, wherein the plurality of tasks are respectively brand names of the plurality of items.

8. The information processing apparatus according to claim 1, wherein the prediction unit predicts the similar user group using a learning model for machine learning that is configured to receive, as inputs, the user features of the target user group and the user representations, and outputs a likelihood of having features similar to those of users included in the model user group.

9. The information processing apparatus according to claim 8, wherein the prediction unit predicts one or more users having the likelihood larger than a predetermined threshold as the similar user group.

10. The information processing apparatus according to claim 1, further comprising
a distribution unit configured to distribute an advertisement to the similar user group.

11. An information processing method comprising:
selecting, from a plurality of users, a model user group and a target user group that is different from the model user group;
generating, for each user of the target user group, a user representation representing relationships with the plurality of users and the plurality of items; and
predicting, based on the user representation, one or more users that have features similar to those of users included in the model user group, from the target user group, as a similar user group.

12. A non-transitory computer readable medium storing a computer program for causing a computer to execute processing comprising:
selection processing for selecting, from a plurality of users, a model user group and a target user group that is different from the model user group;
generation processing for generating, for each user of the target user group, a user representation representing relationships with the plurality of users and the plurality of items; and
prediction processing for predicting, based on the user representation, one or more users that have features similar to those of users included in the model user group, from the target user group, as a similar user group.
